(19) United States
(12) Patent Application Publication
(10) Pub. No.: US 2012/0270602 A1
(43) Pub. Date: Oct. 25, 2012

(54) MULTIPLE SUBSCRIBER IDENTITY MODULE CONTROLLER

(76) Inventor: Robert A. Card, Scarborough, ME (US)

(21) Appl. No.: 13/093,096

(22) Filed: Apr. 25, 2011

(51) Int. Cl. H04B 1/38

(52) U.S. Cl. 455/558

(57) ABSTRACT

The present application discusses, among other things, apparatus to reduce the amount of processor general purpose input or outputs consumed to interface simultaneously with multiple subscription identification modules (SIMs). In an example, an apparatus can include a controller, first and second subscriber identity module (SIM) ports configured to transmit SIM information between the controller and first and second SIMs coupled to the first and second SIM ports, and a communication controller configured to couple to a base band processor using a two-wire serial communication bus, the communication controller configured to transmit the SIM information between the controller and the base band processor.

### BACKGROUND

Subscriber identity modules (SIMs) are memory modules typically used to store, among other things, information necessary to configure and identify mobile wireless communication devices, such as cell phones, to a communication system used to support the use of each wireless communication device on the communication system. However, differences between particular communication systems, such differences between wireless cell phone systems, or the format or location of the stored information on a SIM can be so disparate that a separate SIM can be required to identify and operate a device on a particular communication system. Users may often need to operate a communication device, such as a cell phone on two different cell phone systems. Present cell phones can allow the use of dual SIMs to accommodate these users, however, a second SIM interface consumes valuable baseband processor general purpose inputs and outputs (I/O) that can otherwise save space or be used for interfacing to sensors or transducer that can enhance the functionality of the cell phone or other mobile electronic device.

### OVERVIEW

In certain examples, an apparatus can include a controller, first and second subscriber identity module (SIM) ports configured to transmit SIM information between the controller and first and second SIMs coupled to the first and second SIM ports, and a communication controller configured to couple to a base band processor using a two-wire serial communication bus, the communication controller configured to transmit the SIM information between the controller and the base band processor. The apparatus can be useful to reduce the amount of processor general-purpose inputs and/or outputs (GPIO) consumed to interface simultaneously with multiple subscription identification modules (SIMs).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a system including an example dual SIM controller.

FIG. 2 illustrates generally a system including an example multiple SIM controller that utilizes a reduced number of device processor GPIO to provide an interface between the device processor and multiple SIMs.

FIG. 3 illustrates generally a block diagram of an example multiple SIM controller.

### DETAILED DESCRIPTION

The present inventor has recognized, among other things, that interfacing multiple subscription identity modules (SIMs) to a device processor consumes general-purpose inputs or outputs (GPIO) of the processor that can otherwise be used to interface with sensors or transducers to enhance the functionality of the device. In some examples, reducing the consumption of GPIO used to interface to one or more SIMs can allow for a smaller device processor. In an example, a SIM controller can be used to interface multiple SIMs to a device processor. Compared to applications where at least one of two SIMs is directly coupled to the device processor, the example SIM controller described herein can significantly reduce the number of device processor general purpose I/O needed to interface to multiple SIMs.

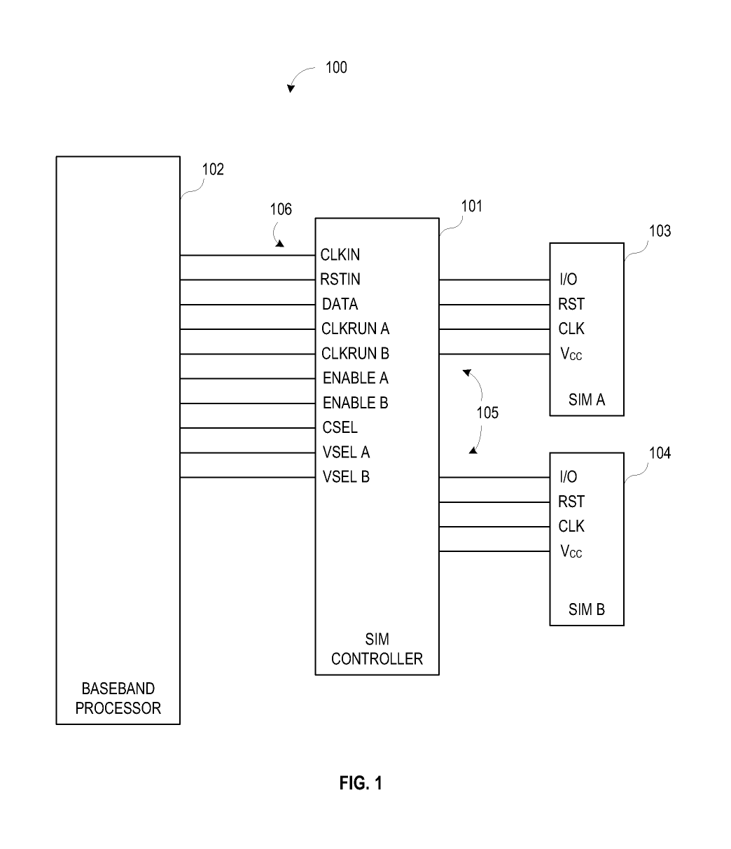

FIG. 1 illustrates generally an example of a system 100 including a dual SIM controller 101, a processor 102, and first and second SIMs 103, 104. The dual SIM controller 101 includes SIM ports 105 configured to interface directly with the first and second SIMs 103, 104. In certain examples, one or more of the SIM ports 105 can include a power terminal configured to provide a supply voltage (V_{CC}) to one or more SIMs, a clock terminal configured to provide a clock signal CLK between the dual SIM controller 101 and one or more SIMs, a reset terminal configured to provide a reset signal (RST) to one or more SIMs, or a data terminal configured to exchange a data signal (I/O) with one or more SIMs.

In an example, the dual SIM controller 101 can include a set of baseband interface terminals 106 configured to interface the dual SIM controller 101 to the processor 102. In certain examples, the baseband interface terminals 106 can include a clock input (CLKIN) configured to receive a clock signal from the processor 102, a reset input (RSTIN) configured to receive a reset signal from the processor 102, or a data terminal (DATA) configured to exchange a data signal with the processor 102. In other examples, the baseband interface terminals 106 can include a pair of inputs, CLKRUN A and CLKRUN B, used to select if a clock signal is always sent to the CLK input of each of the SIMs 103, 104 or if the clock signal to each of the first and second SIMs 103, 104 is gated with a clock select input (CSEL). In an example, the baseband interface terminals 106 can include a pair of inputs, ENABLE A and ENABLE B, used to enable or disable communication between each of the first and second SIMs 103, 104 and the processor 102. In an example, a pair of baseband interface terminals, VSEL A and VSEL B, can be used to select one of two voltages configured to be supplied to the respective first or second SIM 103, 104.

In an example, the system 100 illustrated in the example of FIG. 1 can consume 10 GPIO from the processor 102 to provide an interface to the first and second SIMs 103, 104.

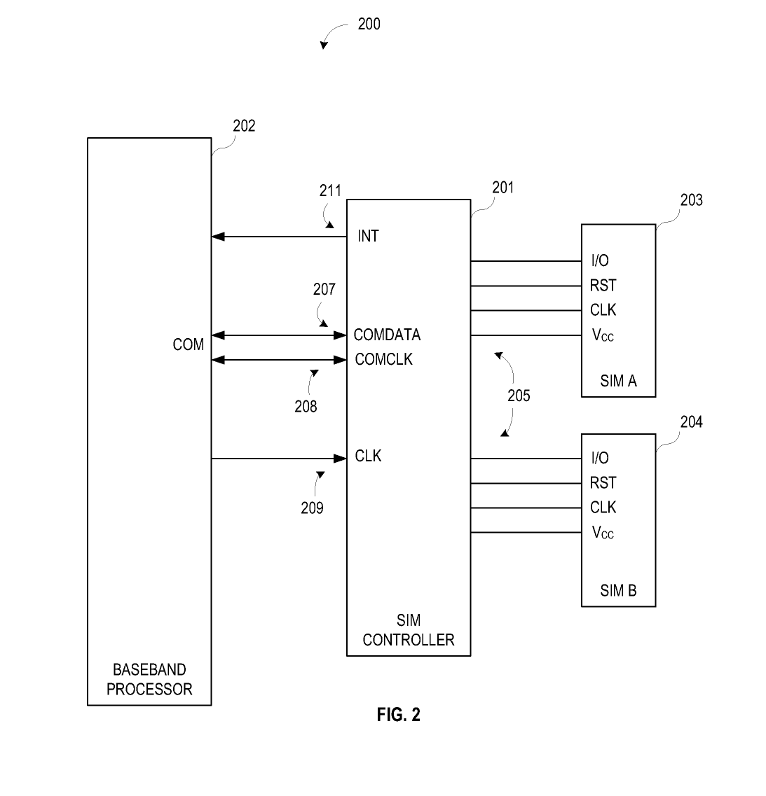

FIG. 2 illustrates generally a system 200 including an example multiple SIM controller 201 configured to utilize a reduced number of GPIO to provide an interface between a device processor 202, such as a baseband processor, and multiple SIMs, such as first and second SIMs 203, 204. The multiple SIM controller 201 includes SIM ports 205 configured to interface the multiple SIM controller 201 with the first and second SIMs 203, 204. In certain examples, one or more of the SIM ports 205 can include a power terminal configured to provide a supply voltage (V_{CC}) to one or more SIMs, a clock terminal configured to provide a clock signal CLK between the dual SIM controller 201 and one or more SIMs, a reset terminal configured to provide a reset signal (RST) to one or more SIMs, or a data terminal configured to exchange a data signal (I/O) with one or more SIMs.

In certain examples, the multiple SIM controller 201 can include two bidirectional ports 207, 208 and an input 209 configured to interface the first and second SIMs 203, 204 with the device processor 202. In an example, the input 209 can receive a clock signal from the device processor 202 and pass the clock signal to the first and second SIMs 203, 204. In an example, the multiple SIM controller 201 can pass a representation of the received clock signal to the first and second SIMs 203, 204. In an example, the two-bidirectional ports 207, 208 can conform to a two-wire communication protocol to communicate information between the device processor 202 and the multiple SIM controller 201. In certain examples, the information can include SIM information that can be transmitted between the multiple SIM controller 201 and at least one of the first or second SIMs 203, 204. In an example, the information can include command information, for example, to select one of the first and second SIMs 203, 204 with which the multiple SIM controller 201 exchanges SIM information. In an example, the information can include status information related to at least one of the status of the multiple SIM controller 201 or the status of at least one of the first or second SIMs 203, 204.

In an example, the multiple SIM controller 201 can include one or more interrupt outputs 211 configured to provide additional information to the device processor 202.

In an example, the system 200 illustrated in the example of FIG. 2 can consume 4 GPIO from the device processor 202 to provide an interface to the first and second SIMs 203, 204. In other examples, this GPIO savings can be distributed among more than two SIMs.

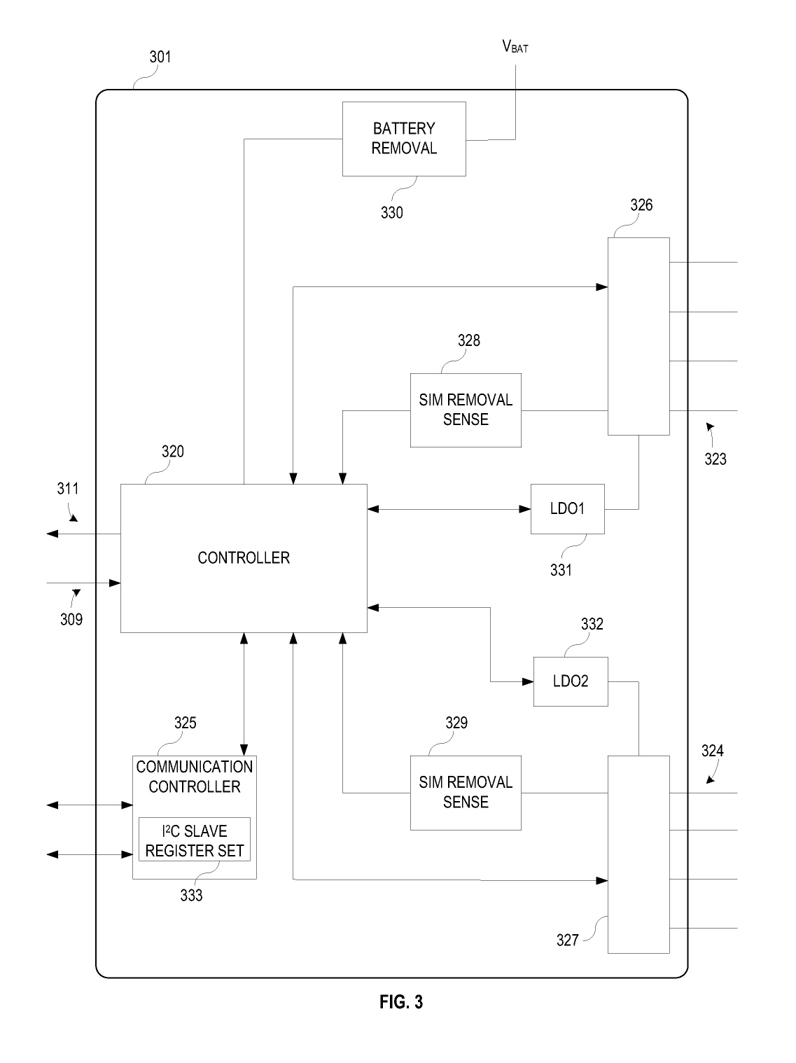

FIG. 3 illustrates generally a block diagram of an example multiple SIM controller 301. In an example, the multiple SIM controller 301 can include a controller 320, such as a state machine, first and second SIM ports 323, 324, and a communication controller 325, such as a two-wire communication controller. In certain examples, the multiple SIM controller 301 is configured to couple to a device processor, such as a baseband processor, for example. In certain examples, the controller 320 can receive, at a clock input 309, a clock signal from an output of a baseband processor, such as a general-purpose output of the baseband processor. In an example, the communication controller 325 can be coupled to a communication controller of a processor, such as a baseband processor. In certain examples, the communication controller 325 can communicate using a two-wire communication bus protocol, such as inter-integrated circuit, or I²C, bus. In some examples, the multiple SIM controller 301 can include slave registers 333 conforming to a two-wire communication bus protocol, such as the I²C bus protocol.

In an example, a first SIM can be coupled to the first SIM port 323 and a second SIM can be coupled to the second SIM port 324. In an example, each of the first and second SIM ports 323, 324 can include a buffer, such as the first or second buffers 326, 327, to exchange information with a SIM coupled to the first or second SIM ports 323, 324. Such information can be exchanged using terminations of the first or second SIM ports 323, 324, such as a clock termination, a data termination, and a reset termination. In an example, each of the first or second SIM ports 323, 324 can supply power to a respective SIM.

In some examples, the multiple SIM controller 301 can monitor the coupling and uncoupling of the SIMs. In certain examples, the multiple SIM controller 301 includes one or more modules, such as modules 328, 329, configured to monitor at least one of insertion or removal of one or more SIMs. Insertion or removal of one or more of the SIMs can be sensed using hardware, software, or a combination of hardware and software. In certain examples, the controller 320 of the multiple SIM controller 301 can communicate the insertion or removal of the one or more SIMs to the device processor using the communication controller 325. In some examples, the controller 320 of the multiple SIM controller 301 can communicate the insertion or removal of the one or more SIMs to the device processor using an interrupt 311.

In certain examples, the multiple SIM controller 301 can be coupled to a power supply (V_{BAT}), such as a battery. In some examples, a battery sense module 330 can provide information, such as information indicative of a condition of the power supply, to the controller 320. Information about the power supply can include, but is not limited to, power supply voltage, power supply current draw, presence of a power supply, power supply energy storage level, low power supply condition, or combinations thereof. In certain examples, the controller 320 can communicate the information about the battery to the device processor using the communication controller 325. In some examples, the controller 320 can communicate the information about the battery to the device processor using an interrupt 311.

In certain examples, the multiple SIM controller 301 can supply power to one or more SIMs. In an example, at least one of the first or second SIM ports 323, 324 can include a voltage regulator, such as a low-power dropout (LDO) regulator (e.g., LDO1 331 or LDO2 332) configured to supply a voltage to a SIM coupled to the first or second SIM port 323, 324. In an example, one or more of the voltage regulators can allow selection of two or more voltages to be supplied to each of the first or second SIM ports 323, 324. In certain examples, the voltage supplied to the first or second SIM ports 323, 324 can be selected from two or more voltages, or can be selected by programming one or more of the voltage regulators of the multiple SIM controller 301, such as accomplished via at least one of hardware or software. In an example, one or more of the voltage regulators, such as LDO1 331 or LDO2 332, can supply between about 1.65 volts and about 3.6 volts to the first or second SIM ports 323, 324.

### Additional Notes

In Example 1, an apparatus can include a controller, first and second subscriber identity module (SIM) ports configured to transmit SIM information between the controller and first and second SIMs coupled to the first and second SIM ports, and a communication controller configured to be coupled to a base band processor using a two-wire serial communication bus, the communication controller configured to transmit the SIM information between the controller and the base band processor.

In Example 2, the communication controller of Example 1 optionally includes a clock terminal configured to couple to a first wire of the two-wire communication bus.

In Example 3, the communication controller of any one or more of Examples 1-2 optionally includes a data terminal configured to couple to a second wire of the two-wire communication bus.

In Example 4, the apparatus of any one or more of Examples 1-3 optionally includes a first regulator configured to regulate power to the first SIM port.

In Example 5, the first regulator of any one or more of Examples 1-4 optionally includes a first low-power dropout (LDO) regulator.

In Example 6, the first LDO regulator of any one or more of Examples 1-5 is optionally configured to provide between about 1.65 volts and about 3.6 volts.

In Example 7, the apparatus of any one or more of Examples 1-6 optionally includes a second regulator configured to regulate power to the second SIM port.

In Example 8, the apparatus of any one or more of Examples 1-7 optionally includes an interrupt output configured to couple to an interrupt input of the base band processor.

In Example 9, the apparatus of any one or more of Examples 1-8 optionally includes an insertion circuit configured to monitor the first and second SIM ports and to provide first interrupt information to the interrupt output when a SIM is inserted or removed from the first or second SIM port.

In Example 10, the apparatus of any one or more of Examples 1-9 optionally includes a power port configured to receive power from an energy storage device, the energy storage device configured to power the apparatus, and a power circuit configured to monitor a power level of the power supplied to the power port and to provide second interrupt information to the interrupt output, the second interrupt information indicative of a low power supply condition of the apparatus.

In Example 11, a method can include transmitting subscriber identity module (SIM) information between a controller and first and second SIMs coupled to the first and second SIM ports, and transmitting the SIM information between the controller and a base band processor using a two-wire serial communication bus.

In Example 12, the transmitting the SIM information between the controller and the base band processor of any one or more of Examples 1-11 optionally includes transmitting a clock signal on a first wire of the two-wire communication bus.

In Example 13, the transmitting the SIM information between the controller and the base band processor of any one or more of Examples 1-12 optionally includes transmitting a data signal on a second wire of the two-wire communication bus.

In Example 14, the method of any one or more of Examples 1-13 optionally includes regulating power to the first SIM port using a first low-power drop out regulator.

In Example 15, the regulating of any one or more of Examples 1-14 optionally includes providing between about 1.65 volts and about 3.6 volts to the first SIM port.

In Example 16, the method of any one or more of Examples 1-15 optionally includes regulating power to the second SIM port using a second low-power drop out regulator.

In Example 17, the regulating power to the second SIM port of any one or more of Examples 1-16 optionally includes providing between about 1.65 volts and about 3.6 volts to the second SIM port.

In Example 18, the method of any one or more of Examples 1-17 optionally includes providing interrupt information from the controller to an input of the base band processor.

In Example 19, the method of any one or more of Examples 1-18 optionally includes providing first interrupt information to the base band processor when a SIM is inserted or removed from either the first or second SIM port.

In Example 20, the method of any one or more of Examples 1-19 optionally includes providing second interrupt information to the base band processor, the second interrupt information indicative of a low power supply condition of the controller.

Example 21 can include, or can optionally be combined with any portion or combination of any portions of any one or more of Examples 1-20 to include, subject matter that can include means for performing any one or more of the functions of Examples 1-20, or a machine-readable medium including instructions that, when performed by a machine, cause the machine to perform any one or more of the functions of Examples 1-20.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising
a controller;
first and second subscriber identity module (SIM) ports configured to transmit SIM information between the controller and first and second SIMs coupled to the first and second SIM ports; and
a communication controller configured to be coupled to a base band processor using a two-wire serial communication bus, the communication controller configured to transmit the SIM information between the controller and the base band processor.

2. The apparatus of claim 1, wherein the communication controller includes a clock terminal configured to couple to a first wire of the two-wire communication bus.

3. The apparatus of claim 2, wherein the communication controller includes a data terminal configured to couple to a second wire of the two-wire communication bus.

4. The apparatus of claim 1, including a first regulator configured to regulate power to the first SIM port.

5. The apparatus of claim 4, wherein the first regulator includes a first low-power dropout (LDO) regulator.

6. The apparatus of claim 5, wherein the first LDO regulator is configured to provide between about 1.65 volts and about 3.6 volts.

7. The apparatus of claim 4, including a second regulator configured to regulate power to the second SIM port.

8. The apparatus of claim 1 including an interrupt output configured to couple to an interrupt input of the base band processor.

9. The apparatus of claim 8, including an insertion circuit configured to monitor the first and second SIM ports and to provide first interrupt information to the interrupt output when a SIM is inserted or removed from the first or second SIM port.

10. The apparatus of claim 8, including a power port configured to receive power from an energy storage device, the energy storage device configured to power the apparatus; and
a power circuit configured to monitor a power level of the power supplied to the power port and to provide second interrupt information to the interrupt output, the second interrupt information indicative of a low power supply condition of the apparatus.

11. A method comprising
transmitting subscriber identity module (SIM) information between a controller and first and second SIMs coupled to the first and second SIM ports; and
transmitting the SIM information between the controller and a base band processor using a two-wire serial communication bus.

12. The method of claim 11, wherein the transmitting the SIM information between the controller and the base band processor includes transmitting a clock signal on a first wire of the two-wire communication bus.

13. The method of claim 12, wherein the transmitting the SIM information between the controller and the base band processor includes transmitting a data signal on a second wire of the two-wire communication bus.

14. The method of claim 11, including regulating power to the first SIM port using a first low-power drop out regulator.

15. The method of claim 14, wherein the regulating includes providing between about 1.65 volts and about 3.6 volts to the first SIM port.

16. The method of claim 14, including regulating power to the second SIM port using a second low-power drop out regulator.

17. The method of claim 16, wherein the regulating power to the second SIM port includes providing between about 1.65 volts and about 3.6 volts to the second SIM port.

18. The method of claim 11, including providing interrupt information from the controller to an input of the base band processor.

19. The method of claim 18, including providing first interrupt information to the base band processor when a SIM is inserted or removed from either the first or second SIM port.

20. The method of claim 18, including providing second interrupt information to the base band processor, the second interrupt information indicative of a low power supply condition of the controller.
